(19) United States
(12) Patent Application Publication
(10) Pub. No.: US 2001/0008168 A1
(43) Pub. Date: Jul. 19, 2001

(54) RESINS FOR THE VACUUM INFUSION OF VEHICLE PARTS

(76) Inventors: ROMAN LOZA, DUBLIN, OH (US); JOHN BRADLEY COYAULT, ASHVILLE, OH (US); BRUCE LEIST BOWEN, LANDCASTER, OH (US)

Correspondence Address: MARY E PICKEN, ASHLAND CHEMICAL COMPANY, P O BOX 2219, COLUMBUS, OH, 43216

(21) Appl. No.: 09/065,985

(22) Filed: Apr. 24, 1998

(51) Int. Cl. B32B 31/00; B29C 65/00

(52) U.S. Cl. 156/278; 156/286

(57) ABSTRACT

This invention is a low viscosity high reactivity unsaturated resin composition useful for making car and truck parts having superior surface smoothness. The parts are made under slight vacuum so that monomer fumes are reduced in comparison with other molding processes.

### BACKGROUND OF THE INVENTION

In the SEEMANN COMPOSITES RESIN INFUSION MANUFACTURING PROCESS (SCRIMP) process described in U.S. Pat. No. 5,316,468, resin is infused into a laminate under vacuum. The vacuum helps remove air from the laminate and ensures a high glass to resin ratio. Other benefits of the technology include reduction of monomer fumes and elimination of weak bonds. The requirements of the infusion process include low resin viscosity for quick filling of the part. The use of vacuum sometimes has certain drawbacks, including print-through of the glass fiber reinforcement, resulting in a rough surface of the molded part.

One technique for eliminating glass print-through is to use a resin system containing a low-profile-additive (LPA). To achieve the desired low viscosity, extra styrene monomer is added. Adding both styrene and LPA reduces the reactivity of the resulting mixture.

### SUMMARY OF THE INVENTION

This invention relates, in part, to the addition of a multifunctional monomer such as pentaerythritol triacrylate to counteract the reduced reactivity. However, the cure of the resulting mixture is not adequate as suggested by a low Barcol hardness. Another aspect of this invention is related to the addition of low viscosity modified acrylic resins such as MODAR® resins. The combination of a multifunctional acrylate and modified acrylic resin not only gives higher Barcol values but also further speeds cure. Thus, the resin combinations of this invention contain a vinyl ester, a LPA, a multi-functional monomer, a modified acrylic resin, and sufficient monofunctional monomer to give a mixture with a low viscosity. These resins cure quickly with a minimum of shrinkage when used to prepare laminates using a resin transfer molding process such as the SCRIMP process. The low shrinkage is apparent in the good surface quality of the laminate.

In a third aspect of this invention the vinyl ester resin is modified by the addition of maleic anhydride during its preparation. The maleic anhydride is thought to react with hydroxyl groups on the vinyl ester polymer giving maleate half esters. The addition of the maleic anhydride enhances the effectiveness of the LPA improving the surface appearance of the molded parts.

The SCRIMP process requires that low viscosity resins be used. Furthermore, the vacuum assisted nature of this resin transfer molding process often produces parts with considerable undesireable glass-fiber print-through because of the high glass to resin ratio and resin shrinkage during cure. Using an LPA can reduce shrinkage; however, LPAs can often decrease the reactivity of the system while viscosity can increase. To reduce viscosity, extra monomer is added. This can further depress reactivity. The speed of cure and/or the completeness of cure are important considerations both from a practical and economic point of view. Techniques exist for improving the speed of cure. These include using more reactive initiators, using copromoters and others known to those skilled in the art. These techniques often suffer from deleterious side-effects. For example, using more reactive initiators may require special handling or refrigeration of the initiator. The use of di, tri, and tetra acrylates in sheet molding compounds (SMC) has been reported by Akiyama et. al (U.S. Pat. No. 5,395,865); and by Reid and Rex (U.S. Pat. No. 5,202,366). In these cases the acrylates act with other components of the system to improve surface qualities of the molded part. High temperature molding conditions are required. The resin compositions of this invention are for use in the SCRIMP or other resin transfer molding processes cured at ambient temperature or slightly elevated temperature.

Addition of LPAs to vinyl ester or unsaturated polyester resins often decreases the reactivity of the system. In a room temperature cure the reduced reactivity is manifested in a longer gel-to-peak time as measured by a standard gel test. Also, the reaction temperature is reduced. This can have a detrimental effect on the performance of the LPA. Shrinkage of the part increases and the surface appearance deteriorates. To meet the low-viscosity requirements of the SCRIMP process high monomer levels are often needed. This can further extend the cure cycle and reduce the effectiveness of the LPA. We have found that the addition of small amounts of multi-functional monomers such as Sartomer SR 444 pentaerythritol triacrylate (PETriA), Sartomer SR 295 pentaerythritol tetraacrylate (PETA) or Sartomer SR 351 trimethylolpropane triacrylate (TMPTA) along with a MODAR® 835 modified acrylic resin can significantly enhance the reactivity of the system and improve the effectiveness of the LPA in controlling shrinkage.

When used in the SCRIMP process these resin compositions make molded parts that cure quickly and have excellent surface properties. The low viscosity of the system allows for the optional addition of filler. This can further improve surface appearance. The filler can also be a hydrated mineral such as alumina trihydrate. Compositions containing hydrated minerals have good fire retardant properties along with good surface appearance. This is of particular importance to the transportation industry.

The resin compositions described here are especially effective when cured at ambient conditions. No special heating of the mold is needed. Heat produced during the cure reaction is sufficient to ensure good surface quality of the final part. This is in direct contrast to the teachings of previous authors who describe needing elevated temperatures for effective use of multi-functional monomers in combination with LPA.

### DETAILED DESCRIPTION OF THE INVENTION

In the following Examples all parts are by weight unless specifically noted otherwise. All patents mentioned herein are specifically incorporated by reference.

### COMPARATIVE EXAMPLE 1

### Vinyl Ester Resin (Bisphenol A epoxy/Novolac Epoxy/THPA)

Comparative HETRON 970-35 vinyl ester resin was made by heating 329.7 g novolac epoxy resin (epoxy equivalent weight 179) to 150°-200° F. and charging 116.2 9. Shell EPON 828 diepoxy bisphenol A resin with air sparge and inert gas blanket, agitating and heating to 250° F. After the epoxy value reached 310, 0.03 g. 30% tetra methyl ammonium chloride (TMAC) in ethylene glycol was added and heating at 250-260° F. continued for one hour. 217.5 glacial methacrylic acid was added and then 0.30 g hydroquinone was added. 6.0 grams TMAC was metered in and the temperature controlled at 250° F. when the epoxy value reached below 3 the resin was cooled to 215° F., 12.0 g. tetrahydrophthalic anhydride (THPA) was added. After cooling 316.86 9. styrene and 0.01 g 8% copper naphthenate and 0.10 ditertiary butyl hydroquinone were added. The epoxy value was 5-10 units above the acid value.

### Comparative Vinyl Ester Resin 2 (Bisphenol A epoxy/Maleic anhydridelepoxy Value Greater than 5)

Comparative AROPOL D1222 vinyl ester resin 2 was made by charging 413.8 grams Shell EPON 828 diepoxy bisphenol A resin (epoxy equivalent weight 188) to a reactor under a 7-9% oxygen air/inert gas sparge, heating to 270-280° F., and adding 0.05 g tetramethyl ammonium chloride, and holding at 250-260° F. continued for one hour. 145.5 g glacial methacrylic acid was added. 0.15 grams hydroquinone were added 0.51 g. maleic anhydride were added and the reactor cooled to 210° F. 0.4 g.tetramethyl ammonium chloride was added and 250° F. maintained. After the acid value dropped below 100, 0.4 q tetramthyl ammonium chloride was added. After the acid value dropped below 100, 0.4 g. tetramethyl ammonium chloride was added. After the acid value dropped below 50, 0.4 g-tetramethyl ammonium chloride was added. The reaction was complete when the acid value was >5.0 and the epoxy value was between 5 and 10.

### EXAMPLE 1

### Vinyl Ester Resin (Bisphenol A epoxy/Novolac epoxy/Maleic Anhydride)

One vinyl ester resin of this invention was made by adding 304.0 g. epoxy novolac resin and 107.1 diepoxy bisphenol resin into a reactor under nitrogen sparge. After heating to 250° F., 0.03 g. 30% tetramethyl ammonium chloride (TMAC) in ethylene glycol (EG) were added. After heating for one hour 200.5 g. glacial methacrylic acid was added, followed by 0.30 g. hydroquinone. 20 g. TMAC in EG were added and the temperature allowed to increase to 250° F. When the acid value dropped to 7, 2.0 g. TMAC in EG were added. Processing continued until epoxy value was reached. After cooling to 215° F., 20.0 g. maleic anhydride were added. After 15 minutes, 360.6 g. styrene were added. 0.02 g. 8% copper naphthenate were added.

### EXAMPLE 2

### Arotech 2000 Vinyl Ester Resin (Bisphenol A Epoxy/Maleic Anhydride/Epoxy Value Less Than 2)

Another vinyl ester resin of this invention was made by adding 144.7 g glacial methacrylic acid to 402.0 g diepoxybisphenol A resin in a reactor under a nitrogen blanket. 51.0 g. maleic anhydride was added and the reactor heated to 235° F. 2.67g tetramethyl ammonium chloride (TMAC (3% in ethylene glycol) was added. When the acid value was <25 and the epoxy value 10-18, 1.33 g TMAC was added. When the epoxy value reached <2,200.0 g. styrene containing 0.09 g. parabenzoquinone was added.

Reactivity of Vinyl Ester Resins

The vinyl ester resins of this invention made according to examples 1 and 2 were tested along with the following additional components.

HETRON D-1527 saturated polyester low profile additive available from Ashland Chemical, Dublin, Ohio.

MODAR 835 urethane modified acrylic resin available from Ashland Chemical, Dublin, Ohio described in U.S. Pat. Nos. 4,480,079, 5,126396 and 5,250,608.

The reactive monomers used in this invention include styrene and a second crosslinkable vinyl monomer having a reactivity ratio (s) with styrene of less than one. Measuring reactivity ratios of monomers is described in F. W. Billmeger, Jr. Textbook of Polymer Science, Wiley-Interscience pages 329-331. Methyl methacrylate has a reactivity ratio with styrene of less than one (0.5-0.6) and is satisfactory as a second crosslinkable vinyl monomer in this invention. U.S. Pat. No. 4,524,162 Union Carbide describes reactivity ratios at column 11 lines 14-70.

Sartomer SR 444, pentaerythritol triacrylate; Sartomer SR 295, pentaerylthritol tetracrylate; or Sartomer 351, trimethylolpropane triacrylate, available from Sartomer Company, Exton, Pa.

A resin composition containing 68.0% RESIN EXAMPLE 1, 8.0% HETRON® D-1527 LPA saturated polyester, 7% MODAR® 835, 5.0% PETA and 12.0% styrene was promoted with 0.20 phr of 6% cobalt and 0.1 phr of N,N-dimethylaniline. The viscosity of this formulation was 170 centipoise. Room temperature gel test data for this composition cured with 1.25 phr of HiPoint-90 methyl ethyl ketone peroxide: gel-time=13.2 min, gel-to-peak=5.7 min, peak temperature=112° C.

A resin composition containing 80.0% Comparative Resin 1, 8.0% HETRON® D-1527 saturated polyester LPA, and 12.0% styrene was promoted with 0.20 phr of 6% cobalt and 0.1 phr of DMA. The viscosity of this formulation was 207 centipoise. Room temperature gel test data for this composition cured with 1.25 phr of HiPoint-90 methyl ethyl ketone peroxide: gel-time=17.7 min, gel-to-peak=7.4 min, peak temperature =11 3C.

The resin of the present invention is more reactive. Comparative Resin 1 shows that in the absence of PETA and MODAR ® 835 modified acrylic resin, the reactivity is substantially lower.

Test Panel From Resin 1

A resin composition (68.0% Resin Example 1, 8.0% HETRON® D-1527, 7% MODAR® 835, 5.0% PETA and 12.0% styrene) was promoted with 0.30 phr of 12% cobalt and 0.2 phr of DMA. To this mixture were added 40.0 phr of calcium carbonate filler (SUPERMITE®, ECC International). The viscosity of this formulation was 665 cps. This resin was used to prepare a test panel using the SCRIMP process. The panel was prepared on a glass plate (14″×14″) which had a gel coat applied to it (Cook Composites 9252 Buff-Back High Gloss). A glass veil (C-3-35, C-glass, 12″×12″) was placed on top of the gel-coat followed by 5 layers of chopped glass mat (Vetrotex CertainTeed M113), a balsa-wood core and 5 layers of chopped-glass mat. The SCRIMP set-up was assembled. The resin was initiated with 1.50 phr of HiPoint-90 MEK-peroxide and infusion was started. The resin gelled in 6.9 min. The panel was demolded after another 1 h and 13 min. Barcol hardness was measured after demolding: @3 hours=39, @24 hours=37 and @72 hours=36. The surface of the panel was free of glass print-through. The LORIA® surface quality analyzer described in U.S. Pat. No. 4,853,777 was used to assess the surface. The test panel had an Ashland Index of 44 indicating a premium class A surface.

Test Panel from Resin Example 2

Panels were prepared as described above using the resin prepared in Example 2. Results are summarized in the following Table and Graph.

| | | Panel | | | |
|---|---|---|---|---|---|
| Resin, | | 1 | Comp 1 | 2 | Comp 2 |
| Composition: | | A | B | C | D |
| RESIN 1* | Wt % | 71.0 | | | |
| COMP 1* | Wt % | | 71.0 | | |
| RESIN 2* | Wt % | | | 75.0 | |
| COMP 2* | Wt % | | | | 75.0 |
| Hetron D1527 | Wt % | 5.0 | 5.0 | 5.0 | 5.0 |
| Modar 835** | Wt % | 7.0 | 7.0 | | |
| PETA (Sartomer SR- | Wt % | 5.0 | 5.0 | | |
| 295) | | | | | |
| Styrene | Wt % | 12.0 | 12.0 | 20.0 | 20.0 |

Laminate Surface Quality--Ashland Index (Al)

| | | | | |
|---|---|---|---|---|
| Al After 7d at RT | 50 | 237 | 206 | 186 |
| Al after 4 h at 160° F. | 56 | 246 | 140 | 209 |
| Notes: | | | | |

| | |
|---|---|
| Inhibitor/Promoter = | 0.30 phr of 6% cobalt NAP-ALL; 0.15 phr of |
| | dimethylaniline; 100 ppm of p-benzoquinone. |
| Initiator = | 1.25 phr of HiPoint 90 MEK-peroxide (Witco) |
| | and 0.50 phr of Lupersol 256 (Elf Atochem). |
| Laminate | Glass plate, gel-coat, STOPRINT polyester veil, 1 |
| construction = | ply BTl's 1608080, 1 ply BTl's 480808, ½″ |
| | balsawood core, 1-ply 160808. |

*made as described in U.S. RE Pat. 35,280 Imperial Chemical Industries
*RESIN 1 is Bisphenol A epoxy/Novolac epoxy/Maleic anhydride/Methacrylic acid
*COMP RESIN 1 is Bisphenol A epoxy/Novolac epoxy/THPA
*RESIN 2 is Bisphenol epoxy/maleic anhydride EV≦2
*COMP RESIN 2 is Bisphenol A epoxy/Maleic Anhydride EV 5-10

These results demonstrate the superior surface quality of panels made using vinyl ester resins 1 and 2 of the present invention.

We claim:

1. A curable molding composition comprising:
a vinyl ester resin made by reacting epoxy novolac resin, diepoxy bisphenol A resin, methacrylic acid and maleic anhydride,
up to 5% multifunctional acrylic modified polyurethane,
thermoplastic saturated polyester low profile additive, multifunctional acrylate, and a mixture of styrene and a monomer having a reactivity ratio with styrene less than one.

2. The composition of claim 1 wherein said vinyl ester resin comprises 12 to 23 moles epoxy novolac resin (epoxy equivalent weight 179), up to 11 moles diepoxy bisphenol A resin (epoxy equivalent weight 188), 23 moles methacrylic acid, and 1.5 to 10 moles maleic anhydride.

3. The composition of claim 2 comprising:
17 moles epoxy novolac resin
5.7 moles diepoxy bisphenol A resin,
23.3 moles methacrylic acid, and
2.0 moles maleic anhydride.

4. A curable molding composition comprising:
a vinyl ester resin made by reacting diepoxy bisphenol A resin,
methacrylic acid, and
maleic anhydride.
up to 5% multifunctional acrylic modified polyurethane, thermoplastic saturated polyester low profile additive, multifunctional acrylate, and
a mixture of styrene and a monomer having a reactivity ratio with styrene less than one.

5. The composition of claim 4 wherein said vinyl ester resin comprises
to moles diepoxy bisphenol A resin (epoxy equivalent weight 188),
to moles methacrylic acid, and
to moles maleic anhydride.

6. The composition of claim 4 comprising
1 mole diepoxy bisphenol A resin
1.5 moles methacrylic acid, and
0.5 moles maleic anhydride.

7. An article of manufacture having superior surface smoothness comprising the reaction product of:
vinyl ester resin,
thermoplastic saturated polyester low profile additive resin,
reactive monomers,
up to 10% multifunctional acrylic modified polyurethane, and
promoter, having 150-599 centipoise viscosity prior to addition of initiator, and
initiator,
made at ambient temperature and atmospheric pressure or less than atmospheric pressure.

8. The article of claim 7 wherein said vinyl ester resin is made by reacting epoxy novolac resin, diepoxy bisphenol A resin, methacrylic acid, and maleic anhydride.

9. The article of claim 7 wherein said vinyl ester resin has an acid value from 7 to 17, an epoxy value ≦9 and is made by reacting
diepoxy bisphenol A resin,
methacrylic acid, and
maleic anhydride.

10. The article of claim 7 wherein said reactive monomers comprise styrene and a monomer having a reactivity ratio with styrene less than one.

11. The article of claim 10 wherein said reactivity ratio is less than 0.6.

12. The article of claim 11 wherein said monomers are styrene and methyl methacrylate.

13. The article of claim 7 comprising, based on 100% solids,
25-62% vinyl ester resin,
2-10% additive resin,
35-60% reactive monomer,
up to 15% acrylic modified polyurethane.

14. The article of claim 9 wherein said epoxy value is ≦2.

15. The article of claim 10 wherein said vinyl ester resin comprises
12-23 moles novolac epoxy vinyl ester resin (EEW 179)
up to 11 moles diepoxybisphenol A resin (EEW 188)
23 moles methacrylic acid and
1.5-10 moles maleic anhydride
and said reactive monomers are styrene and a second
monomer having a reactivity ratio with styrene less than one.

16. The article of claim 8 wherein said vinyl ester resin comprises
17 moles novolac epoxy vinyl ester resin (EEW=179)
5.7 moles diepoxy bisphenol A resin (EEW=188)
23.3 moles methacrylic acid, and
2.0 moles maleic anhydride.

17. The article of claim 7 wherein said vinyl ester resin comprises
moles diepoxybisphenol A resin (EEW 188),
moles methacrylic acid and
moles maleic anhydride
and said reactive monomers are styrene and a second monomer having a reactivity ratio with styrene less than one.

18. The article of claim 17 wherein said vinyl ester resin comprises
moles diepoxybisphenol A resin,
moles methacrylic acid, and
moles maleic anhydride.

19. The article of claim 7 wherein said reaction occurs in the absence of filler.

20. The article of claim 7 wherein said reaction product further comprises up to 11 parts multifunctional acrylate.

21. The article of claim 20 wherein said multifunctional acrylate is pentaerythritol tetracrylate, or trimethylolpropane triacrylate.

22. A method of making unsaturated resins useful for vacuum infusion molding of vehicle parts comprising the steps of:
admixing vinyl ester resin, thermoplastic saturated polyester low profile additive, reactive monomer, up to 5% multifunctional acrylic modified polyurethane, reaching 150 to 500 centipoise viscosity, and storing said resin.

23. The method of claim 22 wherein said vinyl ester resin is prepared by reacting epoxy novolac resin, diepoxy bisphenol A resin, methacrylic acid, and maleic anhydride.

24. The method of claim 22 wherein said vinyl ester resin has ≦2 epoxy value and 7-17 acid value and is made by reacting diepoxy bisphenol A resin, methacrylic acid, and maleic anhydride.

25. The method of claim 22 occurring in the absence of filler.

26. The method of claim 21 wherein said admixture further comprises multifunctional acrylate.

27. The method of claim 22 comprising
25-62% vinyl ester resin
2-10% additive resin
35-60% reactive monomer
up to 5% multifunctional acrylic modified polyurethane, and
up to 11 parts multifunctional acrylate.

28. The method of claim 27 wherein said multifunctional acrylate is pentaerythritol tetracrylate, or trimethylol propane triacrylate and said reactive monomers are a mixture of styrene and a second monomer having a reactivity ratio with styrene less than one.

29. A method of making a vehicle part by the vacuum infusion process at ambient temperature comprising the steps of applying gel coat to a substrate, placing glass veil on said coat, layering chopped glass mat on said veil, adding balsa wood core, adding chopped glass mat,
sealing said layers, applying vacuum, infusing an initiated mixture of
vinyl ester resin
thermoplastic saturated polyester low profile additive
reactive monomer, and
up to 5% multifunctional acrylic modified polyurethane
wherein said mixture has a viscosity below 1000 centipoise prior to addition of initiator.

30. The method of claim 29 wherein said vinyl ester resin is made by reacting epoxy novolac resin, diepoxy bisphenol A resin, methacrylic acid, and maleic anhydride.

31. The method of claim 29 wherein said vinyl ester resin is made by reacting
diepoxy bisphenol A resin,
methacrylic acid, and
maleic anhydride, and
has epoxy value ≦2 and acid value 7-17.

32. The method of claim 29 wherein said initiated mixture lacks filler.

33. The method of claim 29 wherein said mixture further comprises up to 11 parts multifunctional acrylate.

34. The method of claim 29 wherein said multifunctional acrylate is pentaerythritol tetracrylate, or trimethylolpropane triacrylate and said reactive monomer is a mixture of styrene and a second monomer having a reactivity ratio with styrene less than one.
